(19) United States
(12) Patent Application Publication
(10) Pub. No.: US 2012/0330757 A1
(43) Pub. Date: Dec. 27, 2012

(54) DIGITAL ADVERTISING TRADE AMPLIFIER

(75) Inventors: David Heidenreich, Mt. Lebanon, PA (US); Michael O'Toole, Pittsburgh, PA (US); Greg Smith, Wexford, PA (US)

(73) Assignee: Smith Brothers Agency, LP, Pittsburgh, PA (US)

(21) Appl. No.: 13/528,971

(22) Filed: Jun. 21, 2012

Related U.S. Application Data
(60) Provisional application No. 61/500,884, filed on Jun. 24, 2011.

(51) Int. Cl. G06Q 30/02

(52) U.S. Cl. 705/14.72

(57) ABSTRACT

In accordance with one example embodiment of a Digital Advertising Trade Amplifier system, the system comprises a processing engine and content server for dynamically generating digital ad content relating to trade events or trade promotions from ad copy and images for a product and/or a service sold through a retail business, a database for storing the ad copy, the images, and the trade event digital ad content, and an administrative tool for inputting the ad copy and images into the database and configuring programs and for facilitating functionality between the database and the processing engine and content server in order to create, modify, and disseminate the trade event digital ad content. The trade event digital ad content is used to create a trade-specific digital ad based on at least one of an event location, an event date, and contextual placement of the trade event digital ad content.

### CROSS REFERENCE

This application claims the benefits of U.S. Provisional Patent Application Ser. No. 61/500,884, filed on Jun. 24, 2011, the entire contents of which are incorporated herein by reference.

### BACKGROUND

The present invention relates to the field of digital advertising for consumer product manufacturers and marketers. More specifically, the present invention relates to a system and method that enables efficient creation and distribution of digital advertising for consumer product manufacturers and marketers. The present invention is also applicable to digital advertising for in-store service promotions.

Currently, product manufacturers/marketers (“PMMs”) that distribute product to consumers through traditional third-party retail channels (mass, grocery, drug, dollar, convenience, hardware, specialty, etc.) and through third-party e-commerce channels (Amazon, walmart.com, Alice.com, etc.) utilize trade promotion as part of their marketing strategy. Trade promotions are limited-time in-store trade events executed by third-party retailers. These trade events offer reduced-price and/or other purchase incentives on featured products on display for sale for a limited time period. Trade funds are the dollars allocated by PMMs and paid to the third-party retailer in order for the products to be included in trade promotions and for the funding of any temporary price reductions. Trade funds can compensate the third party retailer for the right for an item(s) to be included in a trade promotion, for the total or partial value of the item(s) sold at the reduced price, and for other related costs as required by the third party retailer.

In 2010, $34 billion dollars was spent by food and beverage PMMs to fund participation in trade promotions. Funding for trade promotion is, on average, the second-ranked expense for PMMs contributing to profit or loss. Funds allocated by PMMs to trade promotion participation equal, on average, 67% of total marketing expenses. Trade promotion participation is a significant driver of sales volume for PMMs and an important element of overall business. Adequate participation in trade promotion can be a critical factor in maintaining partnership with third party retailers and protecting key points for product distribution. In the future, PMMs expect to maintain or increase investment in trade promotion.

Despite the significant contribution of marketing funds by PMMs to participate in trade promotion, the development of the promotion event and the related marketing and advertising of the trade promotion and/or the item(s) included in the promotion are executed almost exclusively by the third-party retailer. The PMM typically plays a limited or removed role, or is entirely uninvolved, in communicating to product users and potential users about specific trade promotions in which the PMM is a participant.

Trends in the consumer shopping process and in digital media advertising have demonstrated a market opportunity in which PMMs can benefit by amplifying consumer awareness of/participation in trade promotion through advertising in addition to the advertising executed by the third-party retailer. PMMs can influence consumers while in the digital shopping planning process. A PMM can gain market advantage with this strategy against competing PMM items and competing private label items.

Among current trends is the increasing importance that price and discount play in determining purchase. A 2010 study revealed that 87% of shoppers identify price as an important factor in product selection while only 23% identify brand name as an important factor. In 2010 consumers saved $3.7 billion using coupons, a 37% increase since 2008. As high-speed Internet access has become more universal, digital shopping planning resources have matured, and consumers have become more reliant on these tools for planning shopping and determining purchases before they visit a store. Another 2010 study showed that 94% of shoppers now prepare a list prior to shopping and 72% of shoppers never or only occasionally bought something that was not on the prepared list. Among the digital tools shoppers increasingly use in the shopping planning process are PMM websites, PMM newsletters, retailer websites, retailer newsletters, coupon websites, social media destinations, shopping planning applications, blogs, etc. Shoppers are summarizing, reporting, sharing, and receiving this information among a personal network of friends and family via digital platforms such as email, instant messaging, social media, etc.

The sophistication of digital advertising allows for significant message flexibility and delivery flexibility. Advertisement of PMM participation in multiple, simultaneous and ongoing trade promotions to specifically targeted consumers is technically possible. The manual aggregation of the trade promotion details such as the sale price, offer and purchase requirements, the associated third party retailer, the event timing, the relevant geography, etc. and the subsequent manual process for writing, designing, and distributing each unique iteration of the PMM advertising is error prone, in-efficient, and cost-prohibitive.

Referring now to FIG. 1, shown is the current relationship among the market participants in a trade event marketing scenario. A brand team 100 (i.e. the advertiser), consisting of a brand marketing team 101 and a trade marketing team 102 (e.g., a sales team, customer marketing team, customer development team, or the like), is generally responsible for developing, managing, and marketing the PMM's product brand(s). The brand marketing team 101 collaborates with a media agency 103 and a digital agency 110 to develop and deploy a consumer-facing marketing campaign. This typically builds brand equity, drives product awareness and trial, and/or promotes a separate set of offers aimed at consumer A 120. The digital agency 110 collaborates with the media agency 103 to deliver digital ads 108 to publishers 109 through an ad server 104. The ad server 104 typically includes a database 105 and administrative tools 106. The digital ads 108 drive consumers to digital properties 111 (such as a web site, a social media website page (e.g., Facebook®), and others) that are owned by the brand.

The trade marketing team 102 collaborates with a retailer's relevant buyer 118 (i.e. the “category buyer”) to develop and deploy a trade calendar 119, thereby creating trade events 114. A trade calendar 119 is a schedule of trade events which identifies dates, locations, type of promotion, retailers, retailer locations, brands, PMM, etc. relating to the trade event. The buyer 118 works with the brand marketing team 101 or trade marketing team 102 to deliver a trade event 114 that may include some form of retailer marketing 115. In turn, the product is marked down in-store at the retailer's physical site 112 and/or may receive some form of special treatment such as an end-cap or unique display. Such in-store trade event promotions are aimed at consumer B 121, who most likely becomes aware of the promotion in-store, or in some instances, through retailer advertising 115 such as retailer-owned offline and digital properties 117 (e.g. website, circular, e-circular, email, social media platforms, etc.) and other retailer ads 116.

In contrast, consumer A 120 is shown as moving through the entire purchase funnel, even seeing brand advertising, while being unaware of the trade events 114 occurring at local retailers.

It would be advantageous to provide business processes, services, applications, and software that uniquely manage and allow efficient administration of the aggregation of ongoing PMM trade promotion plans; subsequent, variable ad creation, approval, placement and distribution to multiple digital media publishers according to a rule-set pre-determined and influenced by the PMM and the third party retail trade promotions in which it is a participant; and the reporting of facts related to the ads served via this process and the resulting impact on business performance.

The invention would benefit PMM organizations by improving pre-store awareness of trade promotion plans with consumers, thus increasing the number of consumers for which awareness is converted to purchase intent and action, i.e. adding the product to a shopping list followed by a product purchase.

The systems and methods of the present invention provide the foregoing and other advantages.

### SUMMARY

The present invention relates to a digital advertising trade amplifier system and corresponding computerized methods of distributing digital advertising for in-store trade-promotions relating to consumer products, services, or a combination of products and services.

In accordance with one example embodiment of a digital advertising trade amplifier system of the present invention, the system comprises a processing engine and content server for dynamically generating digital ad content relating to trade events or trade promotions from ad copy and images for a product and/or service sold through a retail business, a database for storing the ad copy, the images, and the trade event digital ad content, and an administrative tool for inputting the ad copy and images into the database and for facilitating functionality between the database and the processing engine and content server in order to create, modify, and disseminate the trade event digital ad content. The trade event digital ad content is used to create a trade-specific digital ad based on at least one of an event location, an event date, and contextual placement of the trade event digital ad content.

An ad server may be in communication with the processing engine and content server. The ad server may comprise an ad server database and at least one ad server administrative tool for use in trafficking creative ad content and the trade-specific digital ads.

The trade-specific digital ads may be delivered by the ad server using the trade-specific digital ad content from the processing engine and content server. The trade-specific digital ads may then be placed on websites owned by a publisher and/or electronically transferred to the consumer to expose the consumer to the trade-specific digital ad before the consumer enters the retail business. In addition (or alternatively) the trade-specific digital ads may be automatically linked to digital properties owned or managed by a brand owner or the retail business. Digital properties owned or managed by a brand owner or the retail business may include, for example, brand websites, brand publisher websites, social media, consumer email notifications, e-circulars, electronic newsletters and the like.

The trade-specific digital ads may be generated by importing the ad copy and images into the administrative tool, importing and/or entering information from a trade calendar into the administrative tool, designating selected parameters from the trade calendar to the processing engine and content server, and generating the trade-specific digital ads based on the ad copy, the images, and the selected trade calendar parameters. The trade calendar information may comprise retailer promotions defined by at least one of an offer of monetary or other value, location of a retailer, a date of a promotion, parameters related to the promotion, and the like.

A first user may enter the ad content and images and manage the trade event digital ad content via the administrative tool. In addition, a second user may operate the ad server to execute a plan to deliver mass impression levels and to target advertising to the consumer. This second user may be supported by a brand marketing user that facilitates at least a portion of a coordinated marketing effort with regard to the retail business.

The digital advertising trade amplifier system may further comprise the trade calendar, which is storable in the database. The trade calendar may comprise a schedule of trade events or trade promotions and which identifies one or more parameters relating to each trade event or trade promotion. The trade event or trade promotion may relate to at least one of an offer of monetary or other value, a specific geographical location, a date, a product, a brand, consumer demographics, a retailer, and a retailer marketing event. The trade calendar may also be supported by at least one of a trade marketing user and a buyer associated with the retail business. In such a case, the administrative tool may facilitate at least one of generation of ads for an approval process, viewing and exporting of reports, and viewing of trafficking sheets created by the processing engine and content server. The administrative tool may also facilitate the placement of trade-specific digital ads based on geography-based groupings of stores owned by a specific retail business for use in controlling dissemination of the trade-specific digital ads.

The retail business may comprise one of a grocery store, a department store, a clothing store, a manufacturer outlet shop, a specialty shop, a book and electronic media store, an electronics store, a hardware store, a furniture store, a home goods store, a jewelry store, a retail bank, a sporting goods store, a “wholesale” club store, a convenience store, a pharmacy, a coffee shop, a bakery or other specialty foods store, a franchise, cooperative or agent location, a car dealer, a service station, a chain medical clinic, and a restaurant.

The present invention also includes a computerized method for distributing digital advertising. In an example embodiment of a computerized method of distributing digital advertising for consumer products and/or services in accordance with the present invention, the method may comprise entering ad copy and images into a database via an administrative tool; dynamically generating from the ad copy and images digital ad content relating to trade events or trade promotions for a product or service sold through a retail business; storing the trade event digital ad content in the database; automatically creating a trade-specific digital ad from the trade event digital ad content based on at least one of an offer of monetary or other value, an event location, an event date, and contextual placement of the trade event digital ad content; and electronically disseminating the trade-specific digital ad.

The method may also include additional features discussed above in connection with the various embodiments of the corresponding Digital Advertising Trade Amplifier system.

### BRIEF DESCRIPTION OF THE DRAWINGS

The present invention will hereinafter be described in conjunction with the appended drawing figures, wherein like reference numerals denote like elements, and:

FIG. 1 shows a prior art flow diagram of an existing trade event and digital marketing scheme;

FIG. 2 shows a flow diagram of a trade event and digital marketing scheme in accordance with an example embodiment of the present invention, including an example embodiment of a digital advertising trade amplifier; and

FIG. 3 shows a flow diagram of an example embodiment of the digital advertising trade amplifier in accordance with the present invention;

FIG. 4 shows a flow diagram of an example embodiment of a system for digital political advertising; and

FIG. 5 shows a flow diagram of an example embodiment of a system for digital advertising for franchise, cooperative, and/or dealer network advertising systems.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

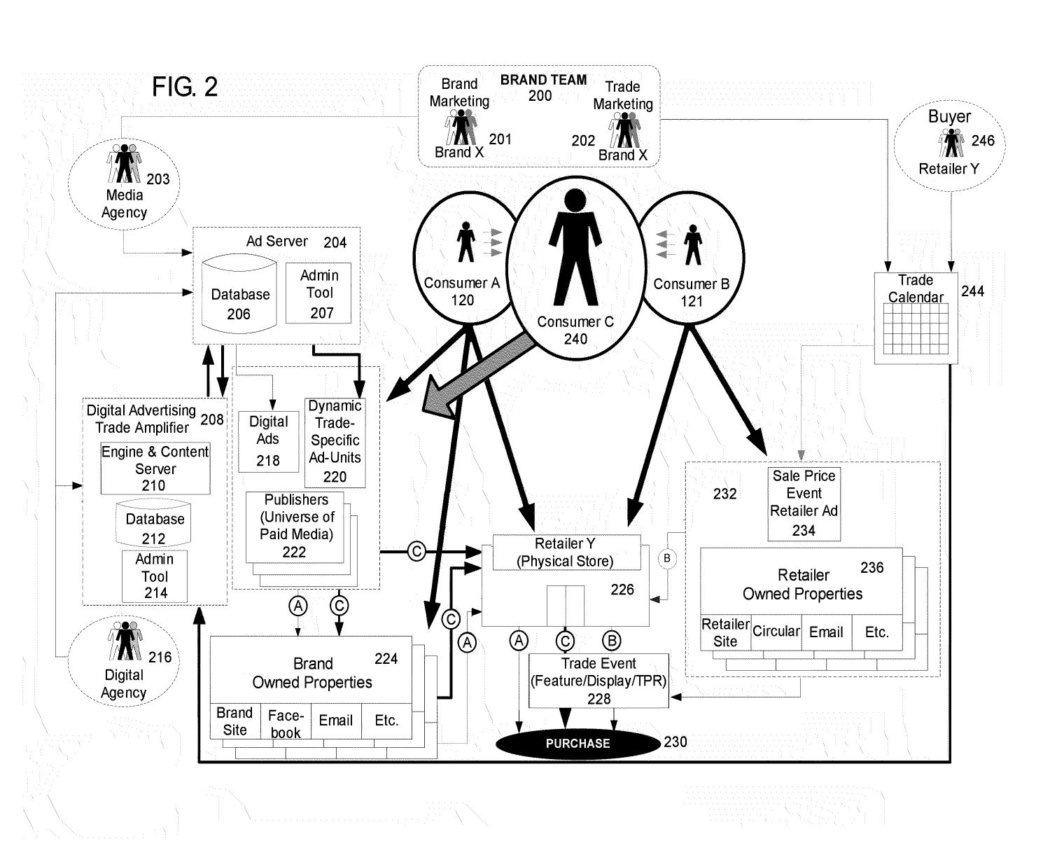

FIG. 2 shows relevant aspects of an example embodiment of a digital advertising trade amplifier system 208 (hereinafter “system 208”) in accordance with the present invention. With the present invention, as compared to the prior art methods, consumer A 120 is still shown as moving through the entire purchase funnel, even seeing brand advertising while being unaware of the trade events 228 occurring at local retailers. Consumer B 121 is shown as making a purchase 230 at a retail business 226 after being aware of the trade events 228 via retailer advertising 232 such as Retailer-owned offline and digital properties 236 (e.g. website, circular, e-circular, email, social media platforms, etc.) and other retailer ads 234. Consumer B 121 becomes aware of the trade event 228 only through his/her experience in-store. The present invention is directed toward converting consumer A 120 and consumer B 121 into consumer C 240 and to growing the consumer C population. Consumer C 240 is shown as making a purchase 230 after being exposed to the digital ads 220 featuring brand and retailer trade promotions before going shopping. Consumer C 240 progresses through the funnel and ends up purchasing the product largely because of being aware of the trade promotion prior to entering a store via an amplified pre-store awareness of a trade event 228 enabled via the present invention.

System 208 comprises a processing engine and content server 210 for dynamically generating digital ad content relating to trade events 228 or trade promotions from ad copy and images for a product and/or service sold through the retail business 226, a database 212 for storing the ad copy, the images, and the trade event digital ad content, and an administrative tool 214 for inputting of the ad copy and images into the database 212 and for facilitating functionality between the database 212 and the processing engine and content server 210 in order to create, modify, and disseminate the trade event digital ad content. The trade event digital ad content (which is dynamically generated by the processing engine and content server 210 from the ad copy and images provided by an advertising agency) is used to automatically create a trade-specific digital ad based on at least one of an event location, an event date, and contextual placement of the trade event digital ad content. The trade-specific digital ads, once created, are disseminated (as discussed in detail below).

It should be appreciated that the term “trade promotion” as used herein is meant to connote any type of in-store promotion, whether for a product, a service, or a service relating to a product or in combination with a product. Accordingly, the trade-specific digital ads may be for products, services, or a combination of products and services. Furthermore, the system 208 may also be used to dynamically serve ad content between a manufacturer of goods and a distributor of the goods for locally provided products and/or services. Additionally, locally provided products may be coupled with a related service (e.g., providing a trade-specific digital ad indicating that a carpet purchase may include discounted local installation services). As used herein, the term “retail business” includes, but is not limited to, grocery stores, department stores, clothing stores, manufacturer outlet shops, specialty shops, book and electronic media stores, electronics stores, hardware stores, furniture stores, home goods stores, jewelry stores, retail banks, sporting goods stores, “wholesale” club stores, convenience stores, pharmacies, franchise, cooperative, or agent locations, car dealers, service stations, and stores that prepare and serve food such as coffee shops, bakeries or other specialty foods stores, restaurants, and chain medical clinics.

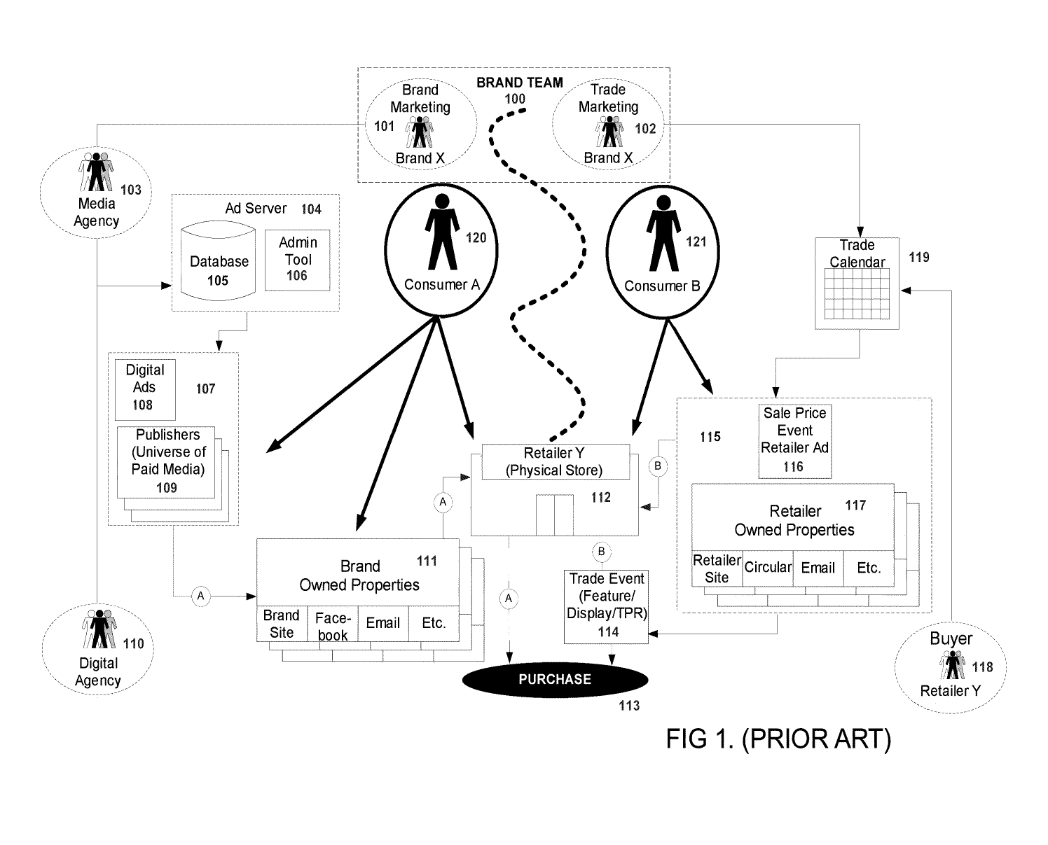

An ad server 204 may be in communication with the processing engine and content server 210. The ad server 204 may comprise an ad server database 206 and at least one ad server administrative tool 207 for use in trafficking creative ad content and the trade-specific digital ads (for example, in an advertisement unit 220). In such embodiments, the trade-specific digital ad may be delivered by the ad server 204 using the trade-specific digital ad content from the processing engine and content server 210. The ad server 204 may also generate digital ads 218 corresponding to digital ads 108 discussed above in connection with FIG. 1.

The trade-specific digital ad may be disseminated in a variety of ways. For example, the trade-specific digital ad may be placed on web sites owned by a publisher 222 and/or electronically transferred to the consumer 240 to expose the consumer 240 to the trade-specific digital ad before the consumer 240 enters the retail business 226. Additionally, or in the alternative, the trade-specific digital ad may be automatically linked to digital properties 224 owned or managed by a brand owner or the retail business. Such digital properties 224 owned or managed by a brand owner or retail business may include, but are not limited to, websites, brand publisher websites, social media, consumer email notifications, e-circulars, electronic newsletters, and the like.

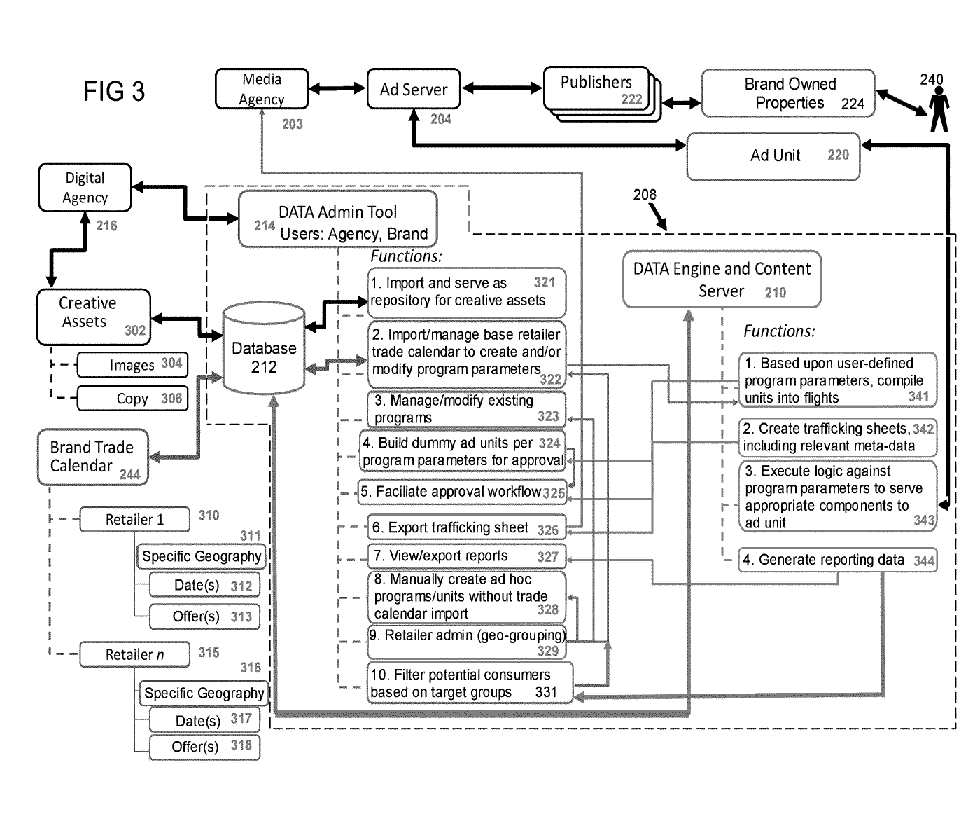

In generating trade-specific digital ads from the ad server 204, the ad copy, images, and information from a product manufacturer/marketer trade calendar 244 (hereinafter “trade calendar 244”) are imported into the administrative tool 214. Referring to FIG. 3, the trade calendar information may comprise retailer promotions defined by at least one of a location of a retailer 311, 316, a date of a promotion 312, 317, and parameters related to the promotion 313, 318. Parameters from the trade calendar 244 are then selected and imported into the processing engine and content server 210. The trade-specific digital ads are then generated based on the ad copy, the images, and the selected trade calendar parameters.

With regard to the ad server 204, a first user may collaborate with at least one of the processing engine and content server 210 and the ad server 204. The first user may enter the ad content and images. The first user may then manage the trade event digital ad content via the administrative tool 214. A second user may also operate the ad server 204 to execute a plan to deliver mass impression levels and to target information to the consumer 240. In embodiments in which a second user operates the ad server 204, the second user is supported by a brand marketing user (or team) 201 that facilitates at least a portion of a coordinated marketing effort with regard to the retail business 226. It should be appreciated that the first user and the second user may be the same person or a related team of people, e.g., at a media agency 203 or from a brand team 200 (or an advertising agency in general).

The system 208 may have a trade calendar 244 associated therewith and storable in the database 212. The trade calendar 244 comprises a schedule of trade events or trade promotions which identify one or more parameters relating to each trade event or trade promotion. The trade event or trade promotion may relate to at least one of a specific geographical location, a date, a product, a brand, consumer demographics, a retailer, a retailer marketing event, and the like.

Additionally, the trade calendar 244 may be supported by at least one of a trade marketing user 202 and a buyer 246 associated with the retail business 226. In such embodiments, the trade marketing user 202 or the buyer 246 associated with the retail business 226 may utilize the administrative tool 214 to facilitate at least one of the generation of ads for an approval process, the viewing and exporting of reports, and the viewing of trafficking sheets created by the processing engine and content server 210. The administrative tool 214 can also be used to facilitate the placement of trade-specific digital ads based on geography-based groupings of stores owned by a specific retail business for use in controlling dissemination of the trade-specific digital ads.

Referring now to FIG. 3, a flow chart of an example embodiment of the system 208 of FIG. 2 is shown. The system 208 includes and may be implemented as a software-based platform that facilitates the management of various functions and processes to enable the execution of the dynamically-served digital advertising campaigns. Components of this platform and process include the processing engine and content server 210, the database 212, and the administrative tool 214, as indicated above. Additional components of this platform and process include the advertising agency (one or more of a digital agency 216, a brand team 200, and a media agency 203), creative assets 302 (e.g., images 304 and ad copy 306) produced by the advertising agency, the ad server 204, advertisement unit 220, publishers 222, and the trade calendar 244.

The trade calendar 244 includes one or more retailer promotions per 1-N retailers 310, 315. Each retailer promotion includes a specific geography (location of a retailer 311, 316) that is a subset of or equal to the total geographic footprint of all the locations of the retailer. The retailer promotion further includes the promotion timing such as the date of the promotion 312, 317 along with the parameters related to the promotion 313, 318 (e.g., details such as “Buy 1, Get 1 Free” and the like).

As shown, the digital agency 216 executes a media buy on behalf of the advertising agency and by extension on behalf of product manufacturers and marketers and the publisher 222, which owns the one or more digital properties (e.g., websites, brand publisher websites, social media, consumer email notifications, e-circulars, and electronic newsletters) on which the advertising appears as discussed above in connection with FIG. 2. A media buy is the purchase of advertising space, such as physical space that appears on a website or a length of time on radio or television broadcast. In the present embodiment, ads trafficked by the digital agency 216 are placed onto the websites owned by the publisher 222 via the ad server 204, disseminated to the brand owned properties 224, and viewed by the consumer 240.

The administrative tool 214 is a browser-based, self-serve software tool operated by an administrative user which is primarily (but is not limited to) a digital marketing specialist of the digital agency 216. The present invention is not limited in this regard, however, as other entities may operate the administrative tool 214, such entities including, but not limited to, those associated with the media agency 203. Still others that may operate the administrative tool 214 include brand marketers 201 and trade marketers 202, as well as, for example, a category buyer 246.

The primary function of the administrative tool 214 includes importing and managing the creative assets 302 and designating the logic of the processing engine and content server 210. Once the creative assets 302 have been produced as images 304 and ad copy 306 by the digital agency 216 according to the requirements of the trade calendar 244 parameters, they are input and/or imported into the database 212 and can be then imported into a repository of the administrative tool 214, as indicated at 321, via action by the administrative user with the administrative tool 214. The administrative user may select the file location of relevant images 304 and ad copy 306 for use in forming trade-specific digital ads according to a specification enforced by the software-based platform. The relevant images 304 and ad copy 306 is then held within the processing engine and content server 210 for later use in building ad units (as described below) facilitated by the administrative tool 214.

The administrative tool 214 also facilitates the importing and managing 322, via action by the administrative user, of existing trade calendars 244 according to a specification enforced by the software-based platform. Once the calendar 244 has been imported, the administrative user may manage and/or make modifications to (or delete), as indicated at 323, parameters such as location of a retailer 311, 316 (e.g., “Geo Groups” or geographical groupings), a date of a promotion 312, 317, and/or other parameters related to the promotion 313, 318. Links (the destination URL(s) of the ad units) and Urchin Tracking Module (UTM) parameters may also be managed and/or modified as desired. In some situations, it may be that custom development work will be undertaken in order to retrieve, via an API (application program interface) or similar framework, the foregoing parameters from a software platform (not shown).

As indicated above, the administrative tool 214 also enables the administrative user to build proposed or “dummy” ad units per advertising campaign parameters for subsequent approval 324. The administrative user may obtain visibility to either “flat” or “live” versions of each ad unit in a specified advertising campaign. The administrative tool 214 will allow these units to be viewed either directly within the workflow or indirectly, for example via a link to a third-party ad serving tool or other repository.

The administrative tool 214 also facilitates the approval of retailer distribution and timing requirements on a scheduled or an as-needed basis, as indicated at 325, and a process of trafficking export sheets, as indicated at 326. A system of tiered permissions/accounts and review/approval mechanisms by which administrative users can share advertising campaign parameters and details with “approver” users is also facilitated. Such advertising campaign parameters and details include, but are not limited to, location of a retailer 311, 316, date of a promotion 312, 317, other parameters related to the promotion 313, 318, links, and UTM parameters. The approver users are able to view (but not edit/modify advertising campaign parameters and details) and approve ads and advertising campaigns. Implicitly, if one or more approver users are granted access to the system 208, un-approved ads or advertising campaigns may not be trafficked through the trafficking sheet process 326. Therefore, approver users are not mandatory with regard to system 208.

With regard to the trafficking sheet process 326, a trafficking sheet is used within a digital marketing campaign by the advertising agency to convey which ad units should be used with which publisher 222 and during which specific timing period. The trafficking sheet is then, in turn, input, for example by the media agency 203, into the ad server 204. Using system logic, the processing engine and content server 210 then creates a trafficking sheet 342 according to the parameters of the advertising campaign (e.g., location of a retailer 311, 316, a date of a promotion 312, 317, other parameters related to the promotion 313, 318, links, and UTM parameters, and the like) as well as an ad unit template.

In the trafficking sheet process 326, the administrative tool 214 also allows for the viewing and exporting of the trafficking sheet in various formats (e.g., .CSV, .XLS, .XLSX, and the like), to facilitate simple sharing among entities associated with the advertising campaign.

The administrative tool 214 also enables viewing and exporting of reports, as indicated at 327. For example, the administrative tool 214 may allow a user to define parameters for the generation of reports 344 from the processing engine and content server 210. These reports include, but are not limited to, information indicative of location of a retailer 311, 316, date of a promotion 312, 317, the various other parameters related to the promotion 313, 318, links, and UTM parameters, and the like. As with the trafficking sheet process 326, the administrative tool 214 allows for the viewing and exporting of the trafficking sheet in various formats (e.g., .CSV, .XLS, .XLSX, and the like).

The processing engine and content server 210 can facilitate live dynamic ad serving calls, as discussed in detail above. In addition, the administrative tool 214 may allow for the manual creation of ad hoc advertising campaigns without trade calendar 244 imports, as indicated at 328. For example, in some cases there may not be a trade calendar 244, or the existing trade calendar 244 is not in the specified format usable to the administrative tool 214, the administrative user may choose to generate an advertising campaign from scratch. The administrative tool 214 may facilitate such a task by allowing the administrative user to specify the retailers 310, 315, location of a retailer 311, 316, date of a promotion 312, 317, the various other parameters related to the promotion 313, 318, links, and UTM parameters, and the like, as well as approval chain distribution parameters and timing requirements. As with an ad campaign developed by importing a trade calendar 244, the administrative tool 214 will manage/modify existing programs 323, build dummy ad units per program parameters for approval 324, facilitate approval workflow 325, export trafficking sheets 326, and view/export reports 327 for ad-hoc functions.

The administrative tool 214 also enables geographical grouping by retailer administration 329. It is possible that a retailer 310, 315 may have a geographical footprint which exceeds the relevant geography for a specific ad campaign. Therefore, in such cases it is desirable that the administrative tool 214 facilitate a retailer administration 329 function for the administrative user. The administrative user will be able to select retailers 310, 315 currently in the system, or enter a new retailer. In addition, the administrative user will be able to import and/or enter lists for the selected retailer 310, 315 by specifying one or more parameters, for example, store name/number, street address, city, state, ZIP code, marketing area (e.g., a marketing area based on census-based metropolitan area designations or the like), and corporate/franchise status.

The administrative user may also use standard select/de-select mechanisms to create, modify, and delete geographical groupings within the selected retailers 310, 315 according to the above parameters. For example, if the selected retailer 310 is grocery store from a chain of grocery stores, the administrative user may have available a .CSV file (organized according to a specification enforced by the administrative tool 214) in which all the stores in the chain are organized according to ZIP code and marketing area. By using the mechanism of retailer administration 329 within the administrative tool 214, the administrative user may create two retailer locations 311 within the total store list, for example, one named “Pittsburgh” and one named “Cleveland.” Further, the administrative user can use the mechanism of the retailer administration 329 to modify existing retailer locations 311 as part of a planned advertising campaign in such a way that the original geographical grouping of retailer locations 311 remains intact. For example, the administrative user may choose to modify the “Cleveland” geographical grouping for a particular program such that only certain ZIP codes within the “Cleveland” geographical grouping for the chain are included.

The administrative user may also be able to filter potential consumers based on a target group by using a filtering function 331. For example, some people may be screened out from receiving ads or targeted to receive ads based on their purchasing history, geographic location, demographics, and the like.

The processing engine and content server 210 is implemented as a server-based, automated software tool controlled or operated primarily through the administrative tool 214. The processing engine and content server 210, under control of the administrative tool 214, can build dummy ad units per program parameters for ad approval 324, facilitate approval of workflow 325, export trafficking sheets 326, and view/export reports 327.

The ad server 204 may pass geographic data (or other data) to the advertisement unit 220. The ad units may include templates and logic functions by which the trade-specific digital ads may be automatically created (e.g., upon receipt of the geographic or other data from the ad server 204), thereby allowing the processing engine and content server 210 to dynamically serve the trade-specific digital ads in real time.

The primary functions of the processing engine and content server 210 include compiling ad units based upon program parameters 341 defined by the administrative user and merging the information pertaining to location of a retailer 311, 316, date of a promotion 312, 317, various other parameters related to the promotion 313, 318, links, and UTM parameters. The templates in the advertisement unit 220 contain proprietary communication logic which passes geographic-related parameters (or other data such as date/time or media targeting data) to the processing engine and content server 210, where corresponding communication logic processes 343 and communicates the appropriate creative assets 302 (images 304 and copy 306) for the advertising campaign back to the advertisement unit 220, thus building the trade-specific digital ads dynamically, or returning “national/default” creative assets 302 where appropriate (i.e. in geographies where or during times when no ad amplification should occur, per the user's configuration of programs). An additional process of the system is determining whether there exists geographic and temporal conflicts among two or more programs. The admin tool 214 facilitates the resolution of such conflicts and the resolution logic 343 is communicated to the advertisement unit 220, thus designating to correct images 304 and copy 306 to be rendered into the advertisement unit 220.

The processing engine and content server 210 also creates trafficking sheets including relevant meta-data 342 (e.g., brand hierarchy, retailer associations, unit specifications, and so forth). The processing engine and content server 210 compiles the program parameters into these trafficking sheets including the relevant meta-data 342, which are then made available to the administrative tool 214 for export via export trafficking sheets 326.

The processing engine and content server 210 further executes logic 343 against program parameters to communicate appropriate components to the templates in the advertisement unit 220. Specifically, the processing engine and content server 210 may receive a query, which includes geographical data (or other data) of the consumer and relevant meta-data 342, from the advertisement unit 220, and compare current date-time against the trade calendar 244 of the relevant meta-data 342 for eligibility for a trade-amplified version, i.e. a version of ad unit featuring messaging related to a specific trade promotion (e.g. “$2 off, this week at Storename”). If the current intersection of date-time and geography is outside of any event on the trade calendar 244, the “national/default” ad unit is appropriate and the processing engine and content server 210 communicates back to the advertisement unit 220 accordingly with the necessary creative asset references 302. If the intersection of the geography and current date-time corresponds with one or more events on the trade calendar 244, the processing engine and content server 210 communicates the appropriate values and/or creative asset references 302 back to the advertisement unit 220. The appropriate values and/or creative assets 302 include, but are not limited to, images 304 pertaining to the retailer (e.g., logo image and/or retailer name copy), copy 306 pertaining to the retailer (e.g., offers), links, and UTM parameters.

The processing engine and content server 210 also generates reporting data 344. The processing engine and content server 210 retains instance-level advertisement unit 220 data to be used in reporting via the administrative tool 214. Such instance-level advertisement unit 220 data is collected and compiled and includes, but is not limited to, retailers 310, 315, location of a retailer 311, 316, date of a promotion 312, 317, other parameters related to the promotion 313, 318, information relating to the publisher 222, creative assets 302, links, and UTM parameters, and the like.

Those skilled in the art will appreciate that the functions of the brand team 200, brand marketing 201, trade marketing 202, media agency 203, and/or digital agency 216 may be consolidated into one or more entities of the advertising agency (e.g., the media agency 203 and digital agency 216 functions may be carried out by the same company or individuals, or the brand team 200 may include the media agency 203, or the like).

It should also be appreciated that the ad server 204 and the system 208 may be integrated to reduce redundancy (e.g., the system 208 may be used to serve all ads and/or the ad server administrative tool 207 may be consolidated with the administrative tool 214, or the like), or the separate components of these devices 204, 208, may alternatively be located or implemented separately.

Those skilled in the art will appreciate that the present invention is applicable to a wide range of retail locations and to the promotion of various goods and services, and can be adapted to provide geographically specific ad content for localized promotions. Those skilled in the art will also appreciate that the present invention is easily adaptable to types of advertising outside of the retail store trade promotion area, such as conventional product and service advertising, political advertising and campaigning, lobbying efforts, and the like.

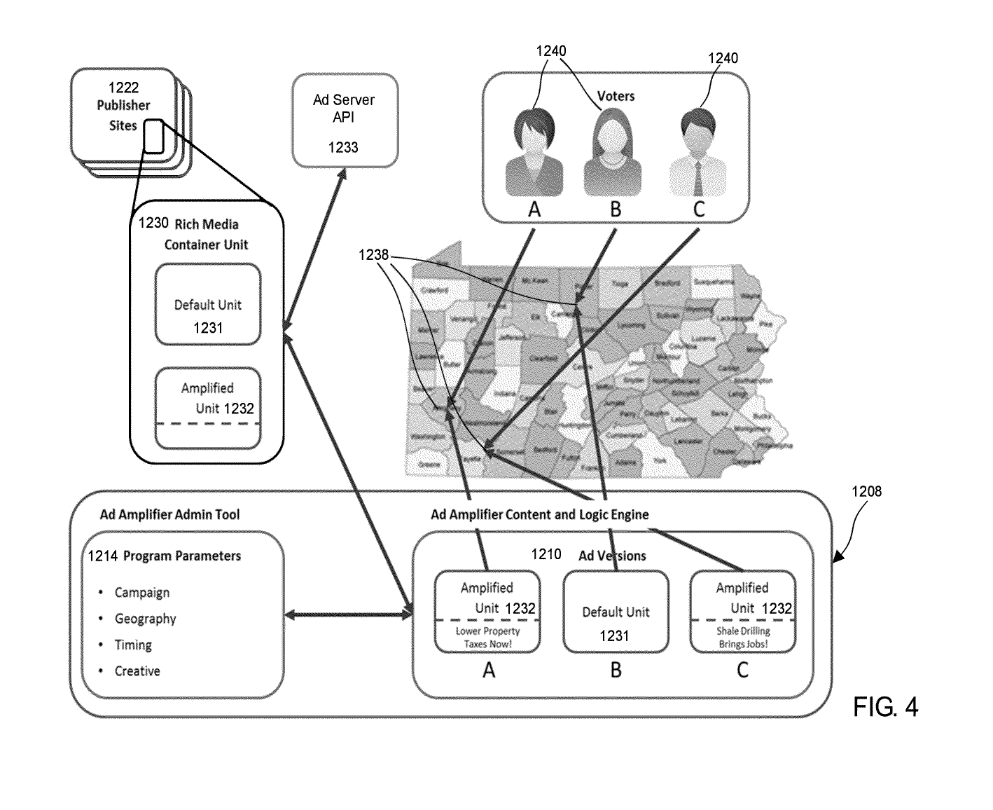

For example, referring now to FIG. 4, the capabilities, technology, and functionality of the system 208 may be adapted to deliver value within the field of digital political advertising (for example, banner-type advertising) in which political messaging is disseminated to prospective voters using an amplified political advertising system, designated by the reference number 1208 (hereinafter “political advertising system 1208”). FIG. 4 shows a high-level block diagram of an example embodiment of a political advertising system 1208, and it should be appreciated that elements corresponding to the system 208 shown in FIGS. 2 and 3 may be adapted for use in the system 1208 (e.g., functionality corresponding to media agency 203, brand team 200, ad server 204, admin tool 207, creative assets 302, calendar 244, and the like, all adapted for the political arena). However, while the underlying technology defining the political advertising system 1208 is similar to the technology defining the system 208 described above, the value proposition (namely, the end result) of the political advertising system 1208 is different than that of the system 208. In particular, while system 208 defines exposing a consumer C 240 to digital ads 220 featuring brand and retailer trade promotions before going shopping, the political advertising system 1208 exposes a potential voter 1240 to a slogan or statement in an effort to sway the potential voter 1240 to a particular politically-oriented viewpoint before entering a voting booth.

The political advertising system 1208 comprises an engine and content amplifier 1210 and an associated ad amplifier administrative tool 1214. The engine and content amplifier 1210 provides the slogans or statements as default ad units 1231 and amplified ad units 1232 using the ad amplifier administrative tool 1214, which tailors the slogan or statement to a particular voter 1240 based on a parameter such as type of campaign, geography, timing, creativity or artistic content of the slogan or statement, or the like. The default ad units 1231 and amplified ad units 1232 are ultimately communicated to a rich media container unit 1230 associated with or located at publisher sites 1222. The publisher sites 1222 may comprise digital properties such as websites, social media, electronic newsletters, email distribution lists, and the like accessible by or provided to the voters 1240. Default (or national) ad units 1231 are disseminated when amplification based on geography and/or time has not been designated.

By using the ad amplifier administrative tool 1214, the default ad units 1231 and amplified ad units 1232 are capable of being trafficked to a potential voter 1240 using only one creative unit. Creative updates to the amplified ad units 1232 can be made without having to utilize the services of a technical resource such as a Flash/rich media developer. This allows the messaging related to the default ad units 1231 and amplified ad units 1232 to be changed in near real-time, allowing for the targeting of political messaging across and within geographic footprints 1238 as desired and for the configuration of ad unit 1232 to dynamically present display content based on date, time, geographic location (for example, by ZIP code or area code), and other targeting possibilities.

The ad server API 1233 of FIG. 4 functions much the same way as ad server 204 discussed above. For example, the ad server API 1233 may pass geographic data (or other data) to the rich media container unit 1230 so that (via the templates and logic functions contained in the container unit 1230 and ad amplifier content and logic engine 1210) specific and targeted political messaging may be automatically rendered.

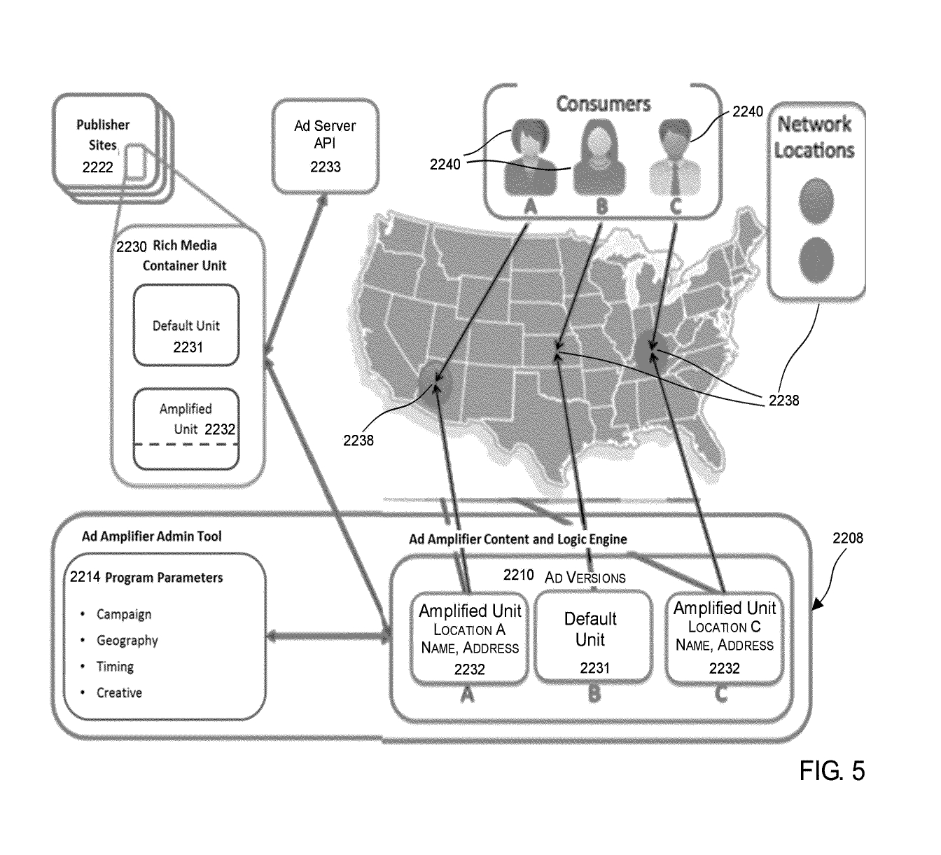

Referring now to FIG. 5, the capabilities, technology, and functionality of the system 208 can also be adapted to deliver value within the field of digital advertising (for example, banner-type advertising) for franchise, cooperative, and/or dealer network advertising scenarios. The foregoing technology is adapted to work for franchise, cooperative, and/or dealer network advertising systems, one of which is designated generally by the reference number 2208 (hereinafter “network advertising system 2208”). FIG. 5 shows a high-level block diagram of an example embodiment of the network advertising system 2208, and it should be appreciated that the elements corresponding to the system 208 shown in FIGS. 2 and 3 may be adapted for use in the system 2208 (e.g., functionality corresponding to media agency 203, brand team 200, the ad server 204, and the like), all adapted for network retailer group structures. However, while the underlying technology remains almost wholly the same as currently configured for system 208, the value proposition is somewhat different. In particular, system 2208 exposes potential consumers 2240 to amplified advertising units for relevant network locations 2238.

The system 2208 comprises an engine and content amplifier 2210 and an associated ad amplifier administrative tool 2214. As with the other systems defined above, the engine and content amplifier 2210 provides advertising as default ad units 2231 or amplified ad units 2232 using the ad amplifier administrative tool 2214, which tailors the amplified ad units 2232 to a consumer 2240 based on one or more parameters such as store name, geography, timing, creativity or artistic content, or the like. The default ad units 2231 and amplified ad units 2232 are ultimately communicated to a rich media container unit 2230 associated with or located at publisher sites 2222. The publisher sites 2222 may comprise digital properties such as websites, social media, electronic newsletters, email distribution lists, and the like accessible by or provided to the consumers 2240.

In a manner similar to system 1208, by using the ad amplifier administrative tool 2214, the default ad units 2231 and amplified ad units 2232 are capable of being trafficked to a potential consumer 2240 using only one creative unit. Creative updates to the amplified ad units 2232 for unique retailers within the network can be made without having to utilize the services of a technical resource such as a rich media developer. This allows the advertising to be purchased more efficiently as geographically vast, bulk media for the national or total network market area of the retailer, and then to easily divide messaging within the purchased digital media across and within geographic footprints featuring details such as the Network retailer's store name, physical location and/or address and contact information for the relevant, specific and unique retailer entities in the Network by dynamically presenting display creative to the target according to date-time, the ad viewer's geographic position (i.e. ZIP code) and other targeting capabilities. The advertiser can also change network-wide messaging in near-real-time without administering multiple change variations that would be related to providing ad copy referring to a specific network retailer's store name, physical location, or address and contact information.

The ad server API 2233 of FIG. 5 functions much the same way as ad server 204 discussed above. For example, the ad server API 2233 may pass geographic data (or other data) to the rich media container unit 2230 so that (via the templates and logic functions contained in the container unit 2230 and ad amplifier content and logic engine 2210) specific and targeted advertising may be automatically rendered.

It should now be appreciated that the present invention provides advantageous methods and apparatus for amplifying awareness of trade promotions though digital advertising.

Although the invention has been described in connection with various illustrated embodiments, numerous modifications and adaptations may be made thereto without departing from the spirit and scope of the invention as set forth in the claims.

What is claimed is:

1. A Digital Advertising Trade Amplifier system, comprising;
a processing engine and content server for dynamically generating digital ad content relating to trade events or trade promotions from ad copy and images for at least one of a product and a service sold through a retail business;
a database for storing the ad copy, the images, and the trade event digital ad content; and
an administrative tool for inputting of the ad copy and images into the database and for facilitating functionality between the database and the processing engine and content server in order to create, modify, and disseminate the trade event digital ad content;
wherein the trade event digital ad content is used to create a trade-specific digital ad based on at least one of an event location, an event date, and contextual placement of the trade event digital ad content.

2. The system of claim 1, wherein an ad server is in communication with the processing engine and content server, the ad server comprising an ad server database and at least one ad server administrative tool for use in trafficking creative ad content and the trade-specific digital ads.

3. The system of claim 2, wherein the trade-specific digital ad is delivered by the ad server using the trade-specific digital ad content from the processing engine and content server.

4. The system of claim 3, wherein the trade-specific digital ad is placed on websites owned by a publisher and/or electronically transferred to the consumer to expose the consumer to the trade-specific digital ad before the consumer enters the retail business.

5. The system of claim 3, wherein the trade-specific digital ad is automatically linked to digital properties owned or managed by a brand owner or the retail business.

6. The system of claim 5, wherein the digital properties comprise brand websites, brand publisher websites, social media, consumer email notifications, e-circulars, and electronic newsletters.

7. The system of claim 3, wherein the trade-specific digital ads are generated by:
importing the ad copy and images into the administrative tool;
at least one of importing and entering information from a trade calendar into the administrative tool, the trade calendar information comprising retailer promotions defined by at least one of an offer of monetary or other value, a location of a retailer, a date of a promotion, and parameters related to the promotion;
designating selected parameters from the trade calendar into the processing engine and content server;
generating the trade-specific digital ads based on the ad copy, the images, and the selected trade calendar parameters.

8. The system of claim 2, wherein:
a first user enters the ad content and images and manages the trade event digital ad content via the administrative tool.

9. The system of claim 2, wherein a second user operates the ad server to execute a plan to deliver mass impression levels and to target advertising to the consumer.

10. The system of claim 9, wherein the second user is supported by a brand marketing user that facilitates at least a portion of a coordinated marketing effort with regard to the retail business.

11. The system of claim 1, further comprising a trade calendar associated with the Digital Advertising Trade Amplifier system and storable in the database, the trade calendar comprising a schedule of trade events or trade promotions which identifies one or more parameters relating to each trade event or trade promotion.

12. The system of claim 11, wherein the trade event or trade promotion relates to at least one of an offer of monetary or other value, a specific geographical location, a date, a product, a brand, consumer demographics, a retailer, and a retailer marketing event.

13. The system of claim 11, wherein the trade calendar is supported by at least one of a trade marketing user and a buyer associated with the retail business.

14. The system of claim 13, wherein the administrative tool facilitates at least one of generation of ads for an approval process, viewing and exporting of reports, and viewing of trafficking sheets created by the processing engine and content server.

15. The system of claim 13, wherein the administrative tool facilitates the placement of trade-specific digital ads based on geography-based groupings of stores owned by a specific retail business for use in controlling dissemination of the trade-specific digital ads.

16. The system of claim 1, wherein the retail business comprises one of a grocery store, a department store, a clothing store, a manufacturer outlet shop, a specialty shop, a book and electronic media store, an electronics store, a hardware store, a furniture store, a home goods store, a jewelry store, a retail bank, a sporting goods store, a “wholesale” club store, a convenience store, a pharmacy, a coffee shop, a bakery or other specialty foods store, a franchise, cooperative, or agent location, a car dealer, a service station, a chain medical clinic, and a restaurant.

17. A computerized method of distributing digital advertising for consumer products, the method comprising the steps of:
entering ad copy and images into a database via an administrative tool;
dynamically generating from the ad copy and the images digital ad content relating to trade events or trade promotions for a product or service sold through a retail business;
storing the trade event digital ad content in the database; and
automatically creating a trade-specific digital ad from the trade event digital ad content based on at least one of an offer of monetary or other value, an event location, an event date, and contextual placement of the trade event digital ad content; and
electronically disseminating the trade-specific digital ad.

18. The method of claim 17, wherein creative ad content and the trade-specific digital ads are generated using an ad server in communication with the processing engine and content server, the ad server comprising an ad server database and an ad server administrative tool.

19. The method of claim 18, wherein the trade-specific digital ad is delivered by the ad server using the trade event digital ad content.

20. The method of claim 19, wherein the trade-specific digital ad is placed on websites owned by a publisher and/or electronically transferred to the consumer to expose the consumer to the trade-specific digital ad before the consumer enters the retail business.

21. The method of claim 19, wherein the trade-specific digital ad is automatically linked to digital properties owned or managed by a brand owner or the retail business.

22. The method of claim 21, wherein the digital properties comprise brand websites, brand publisher websites, social media, consumer email notifications, e-circulars, and electronic newsletters.

23. The method of claim 19, wherein the trade-specific digital ads are generated by:
importing the ad copy and images into the administrative tool;
at least one of importing and entering information from a trade calendar into the administrative tool, the trade calendar information comprising retailer promotions defined by at least one of an offer of monetary or other value, a location of a retailer, a date of a promotion, and parameters related to the promotion;
selecting one or more parameters from the trade calendar via the administrative tool;
generating the trade-specific digital ads based on the ad copy, the images, and the selected trade calendar parameters.

24. The method of claim 18, wherein a first user enters the ad content and images and manages the trade event digital ad content via the administrative tool.

25. The method of claim 24, wherein a second user operates the ad server to execute a plan to deliver mass impression levels and to target advertising to the consumer.

26. The method of claim 25, wherein the second user is supported by a brand marketing user that facilitates at least a portion of a coordinated marketing effort with regard to the retail business.

27. The method of claim 17, wherein a trade calendar is storable in the database, the trade calendar comprising a schedule of trade events or trade promotions which identifies one or more parameters relating to each trade event or trade promotion.

28. The method of claim 27, wherein the trade event or trade promotion relates to at least one of an offer of monetary or other value, a specific geographical location, a date, a product, a brand, consumer demographics, a retailer, and a retailer marketing event.

29. The method of claim 27, wherein the trade calendar is supported by at least one of a trade marketing user and a buyer associated with the retail business.

30. The method of claim 29, wherein the administrative tool facilitates at least one of generation of ads for an approval process, viewing and exporting of reports, and viewing of trafficking sheets created by the processing engine and content server.

31. The method of claim 29, wherein the administrative tool facilitates the placement of trade-specific digital ads based on geography-based groupings of stores owned by a specific retail business for use in controlling dissemination of the trade-specific digital ads.

32. The method of claim 17, wherein the retail business comprises one of a grocery store, a department store, a clothing store, a manufacturer outlet shop, a specialty shop, a book and electronic media store, an electronics store, a hardware store, a furniture store, a home goods store, a jewelry store, a retail bank, a sporting goods store, a “wholesale” club store, a convenience store, a pharmacy, a coffee shop, a bakery or other specialty foods store, a franchise, cooperative, or agent location, a car dealer, a service station, a chain medical clinic, and a restaurant.
